(19) United States
(12) Patent Application Publication
(10) Pub. No.: US 2007/0241607 A1
(43) Pub. Date: Oct. 18, 2007

(54) Skateboard Wheel with Independently Rotating Disc Assemblies

(76) Inventors: Phillip Hildebrand, Colorado Springs, CO (US); Curtis Schaap, Colorado Springs, CO (US); Todd Vandebrake, Peyton, CO (US); Mark Smit, Colorado Springs, CO (US)

Correspondence Address: Mark Smit, 7535 Vincent Dr., Colorado Springs, CO, 80920, US

(21) Appl. No.: 11/736,550

(22) Filed: Apr. 17, 2007

Related U.S. Application Data
(60) Provisional application No. 60/792,677, filed on Apr. 18, 2006.

(51) Int. Cl. B60B 7/04; B60B 19/00; A63C 17/22

(52) U.S. Cl. 301/5.301; 301/37.25

(57) ABSTRACT

This invention pertains to a specially configured wheel that contains and protects embodiments of multiple discs that rotate or remain stationary relative to other discs in a given embodiment and/or to the wheel.

### CROSS-REFERENCE TO RELATED APPLICATIONS

This is a non-provisional patent application pertaining to, and claiming all benefits of, U.S. Provisional Patent Application No. 60/792,677, with a filing date of Apr. 18, 2006, and with a Title of Invention of “Skateboard Wheel with Independently Rotating Disc Assemblies”.

### STATEMENT REGARDING FEDERALLY SPONSORED RESEARCH OR DEVELOPMENT

Not Applicable.

### REFERENCE TO A SEQUENCE LISTING, A TABLE, OR A COMPUTER PROGRAM LISTING COMPACT DISC APPENDIX

Not Applicable.

### BACKGROUND OF THE INVENTION

This invention pertains to assemblies that consist of a plurality of discs and components that attach to a specially configured wheel. The discs in an assembly rotate with the wheel and/or other discs in the assembly, rotate independently of the wheel and/or other discs in the assembly, or remain stationary while the wheel and/or other discs in the assembly rotate.

There are instances of prior art that apply spinning or stationary objects in relation to a wheel. Most of these instances of prior art apply to automobiles and could not work with a skateboard wheel or the like. Other instances of prior art that could apply to skateboard wheels or the like use widely different techniques to attach their assemblies to the wheels or to present their assemblies than does the present invention. An objective of the present invention is to house a properly configured disc assembly within the confines of the wheel itself. Another objective of the present invention is to provide a simple way to install, change or repair a given disc assembly. Another objective of the present invention is to present an assembly that consists of a plurality of discs that operate independently of the other discs in the assembly. The present invention combines a wheel configuration and various disc assemblies in such manner as to make the present invention novel and unique.

The proper function of the present invention requires the use of a wheel with a specially shaped cavity at its hub. The cavity is used to house the wheel bearings, axle, axle nut and various disc assemblies. Some methods implemented in prior art use wheels with fairly standard cavities included, but the configuration of those cavities and the purpose, position, number and application for the chambers of those cavities are different than those of the present invention.

Given the variations of approaches already shown in prior art, it is obvious that many novel and unique approaches are possible when it comes to wheels and spinning objects. It also demonstrates the ongoing need for such inventions.

### BRIEF SUMMARY OF THE INVENTION

This invention comprises a specially designed skateboard wheel and various disc assemblies that are positioned inside a specially configured cavity in the wheel. The disc assemblies consist of a plurality of discs that are stationary and/or rotate independently of the other disc(s) and/or the wheel. Any given disc assembly attaches to the wheel and/or the skateboard axle. Depending on the configuration, one of the discs rotates with the wheel while the other disc(s) rotate independently of the wheel or one of the discs rotates with the wheel while another disc remains stationary. When one or more discs are rotating or stationary in an independent manner from the wheel, the resulting effect is pleasing and intriguing to those who observe it.

### BRIEF DESCRIPTION OF THE SEVERAL VIEWS OF THE DRAWING

FIG. 1 is a cross-section of the wheel showing its shape and the locations of its basic components.

FIG. 2 is a cross-section of the wheel assembly with the wheel, standard skateboard axle bearings, skateboard axle and axle nut in place.

FIG. 3 shows an isometric view of the outer side of the wheel.

FIG. 4 shows an isometric view of the inner side of the wheel.

FIG. 5 shows cross-section and exploded views of Disc Assembly Configuration 1.

FIG. 6 shows cross-section and exploded views of Disc Assembly Configuration 2.

FIG. 7 shows cross-section and exploded views of Disc Assembly Configuration 3.

### DETAILED DESCRIPTION OF THE INVENTION

This invention comprises variations of a plurality of discs that are configured into an assembly—the assembly being attached to a specially configured wheel. The discs are assembled in such ways as to allow the discs and/or the wheel to rotate independently or in conjunction with each other. The discs can also be configured such that one disc remains stationary while another disc rotates with, and/or independently of, the wheel.

The wheel (1) is cylindrical in shape and contains cavities to house the axle ball bearing assemblies, hereafter referred to as the “axle bearings”, the axle, axle nut, any axle threads that extend beyond the axle nut, and any appropriately configured disc assembly. The cavity in the wheel consists of circular areas of various circumferences and depths and is centered on the axis of the wheel. The wheel is made of polyurethane or other suitable material. The wheel can be machined or molded to the proper shape. The wheel (1) also serves to protect the disc assembly contained within its relevant cavity.

For the purpose of this description, the wheel (1) is considered to have two sides—an “inner” side and an “outer” side. The inner side is the side of the wheel closest to the center plane of the skateboard when the wheel is mounted on the axle. The outer side of the wheel is opposite the inner side and is the side of the wheel that is farthest away from the center plane of the skateboard when the wheel is mounted on the axle of the skateboard. The words “inner” and “inside” are used throughout this description to reference the side or position of a component facing toward, or closer to, the center plane of the skateboard when the wheel is mounted to the skateboard axle. The words “outer” and “outside” are used throughout this description to reference the side or position of a component facing away, or is farther away, from the center plane of the skateboard when the wheel is mounted to the skateboard axle.

The cavity of the wheel is herein described as a series of circular holes, or bores, with various diameters. The smallest bore in the wheel is the axle bore (2). The axle bore is centered on the axis of the wheel such that the wheel rotates around this axis point in balance and without wobble. This bore goes all the way through the wheel. It receives the axle of the skateboard. The wheel thus effectively rotates around the axle with the assistance of two standard ball bearing assemblies.

On the inner side of the wheel is the inner axle bearing bore (3). It is larger in circumference than the axle bore (2) and is designed to house the inner axle ball bearing assembly, hereafter referred to as the “inner axle bearing” or, more generally, an “axle bearing.” The depth of this bore into the inner side of the wheel is as deep as is necessary to house the inner axle bearing, but no deeper. When the inner axle bearing is pressed into this cavity, the inner axle bearing is snugly contained inside the wheel and its inner side lines up with the inner side of the wheel.

On the outer side of the wheel is the outer axle bearing bore (4). This bore is to receive and house the outer axle ball bearing assembly, hereafter referred to as the “outer axle bearing” or, more generally, an “axle bearing.” It is the same circumference as the inner axle bearing bore (3). This cavity is bored deeper than the inner axle bearing bore (3) so that the outer axle bearing is contained well within the wheel. However, this bore is not so deep that it joins with the inner axle bearing bore (3). A section of wheel material exists between the inner and outer axle bearing bores. Only the smaller axle bore (2) extends through the section between the outer axle bearing bore and the inner axle bearing bore. The outer axle bearing bore (4) is deep enough to allow the outer axle bearing to reside well within the wheel, leaving room for the disc assembly bore (5).

The disc assembly bore (5) is positioned farther toward the outer side of the wheel than the outer axle bearing bore (4). It has a larger circumference than the outer axle bearing bore (4), but is not as deep as the outer axle bearing bore (4). The depth of the disc assembly bore (5) allows the wheel to house the disc assembly and the axle nut, but is not so deep as to interfere with the snug and complete fit of the outer axle bearing in the outer axle bearing bore (4).

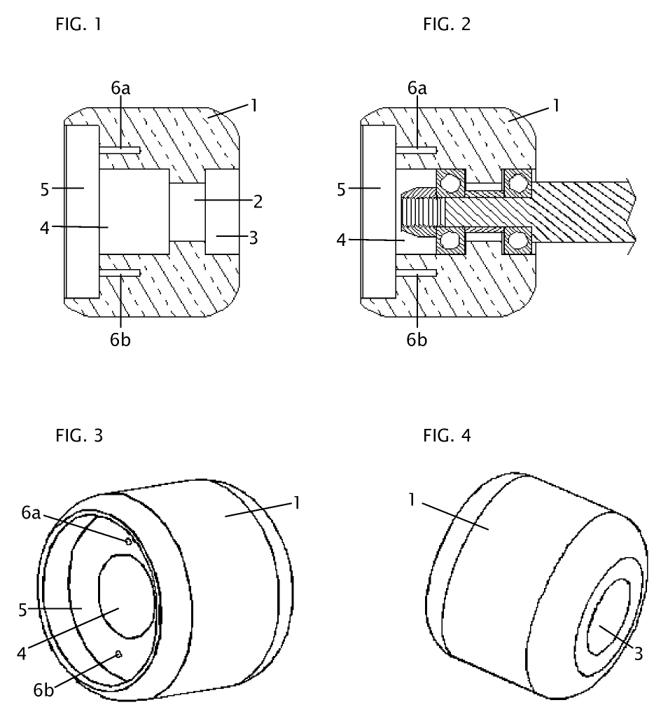

Two disc assembly mounting holes (6a and 6b) are drilled into in the wheel (1). These holes are for the fasteners (7a and 7b) that fasten a disc or a disc assembly to the wheel. These holes are positioned within the diameter of the disc assembly bore (5), yet not within the diameter of the outer axle bearing bore (4). These two disc assembly mounting holes (6a and 6b) are placed opposite each other, relative to the axis of the wheel, so that the wheel maintains rotational balance. The disc assembly mounting holes (6a and 6b) align with inner disc mounting holes (10a and 10b) on the inner disc (11) of the disc assembly. FIG. 1 is a cross-section of the wheel showing its shape and the locations of its basic components.

The “wheel assembly” consists of the wheel (1) as previously described along with two standard skateboard axle bearings. The two standard skateboard axle bearings are inserted into their respective bores (3 and 4) in the wheel (1) from their respective sides of the wheel. FIG. 2 is a cross-section of the wheel assembly with the wheel, standard skateboard axle bearings, skateboard axle and axle nut in place. Note that all the disc assemblies documented here attach to the wheel assembly shown in FIG. 2.

FIG. 3 shows an isometric view of the outer side of the wheel. FIG. 4 shows an isometric view of the inner side of the wheel.

The outer, threaded, end of the axle slides into the axle bore (2) on the inner side of the wheel. It passes through the axle bore (2) and through the centers of the inner and outer axle bearings until its threads are exposed to the disc assembly bore (5) toward the outer side of the wheel. The axle nut is turned onto the axle threads via the disc assembly bore (5) to secure the wheel to the axle. The wheel is sufficiently wide enough on the outer side of the wheel to house the axle nut and tip of the axle that may extend past the axle nut as well as house the disc assembly that is positioned between the end of the axle and the outer side of the wheel. The wheel assembly is secured to the axle using the axle nut prior to fastening the disc assembly to the wheel (1) with the fasteners (7a and 7b). This design permits the installation or exchange of disc assemblies without having to remove the entire wheel assembly from the axle.

The wheel assembly and the method of attaching the wheel to the skateboard axle previously described are the same for each of the disc assembly configurations described hereafter. The disc assembly configurations hereafter described consist of various combinations of discs that are fitted in various ways that rotate around the same axis as the wheel.

The discs, ideally, circular, but the shape of the discs can be non-circular as long as their rotation does not cause excessive vibration. The discs can be made with various patterns bored through their sides or they can have mostly solid surfaces that can contain logos or other advertising or displays. The only holes necessary in the outer disc are one or more holes to allow access to the fasteners that fasten the disc assembly to the wheel assembly. However, attractive designs cut completely through the sides of the discs allow access to the fasteners and also enhance the visual effect of the discs.

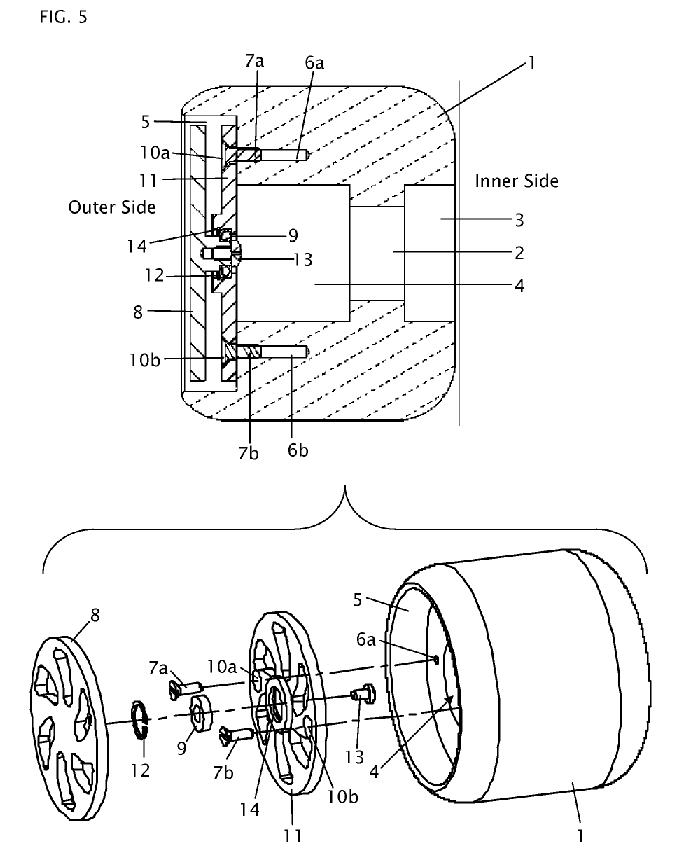

FIG. 5 shows cross-section and exploded views of the embodiment hereafter referred to as Disc Assembly Configuration 1. Disc Assembly Configuration 1 comprises the following parts:
A. The wheel (1) as previously described
B. A disc (8), hereafter referred to as the “outer disc”, with the following characteristics:
   i. A two-level shoulder positioned immediately around its hub on its inner side. The first level of the shoulder is of a larger diameter than the second level of the shoulder. The first level of the shoulder protrudes from the disc. The second level of the shoulder protrudes from the first level of the shoulder. The larger shoulder contacts the inner race of the disc bearing (9) when the outer disc (8) is joined with the inner disc assembly. The smaller shoulder serves as the spindle that seats the inner race of the disc bearing when the outer disc (8) and inner disc assembly are joined. The smaller shoulder contains a threaded bore to receive a machine screw (13), hereafter referred to as the “disc axle screw”. The threaded bore can be a tapped hole into the base material of the outer disc (8) or a threaded insert such as a Helicoil, Keensert, PEM nut or other threaded insert placed in the outer disc (8) to provide the necessary mating threads for the disc axle screw (13).
   ii. Access holes or a decorative design cut through the disc (8) to allow access for mounting.
C. A disc (11), hereafter referred to as the “inner disc”, with the following characteristics:
   i. A shoulder surrounding its hub to its outer side. The shoulder is designed to provide enough width in the center of the disc such that the disc bearing (9) and the retaining ring (1 2) fit inside a bore in that area.
   ii. A bore through the center axis of the shoulder area that is slightly larger in diameter than the outmost edge of the inner race of the disc bearing (9), but not larger in diameter than the disc bearing (9) itself. The inner side of this bore receives the head of the disc axle screw (13).
   iii. A bore in the center of the shoulder area, starting from the outer side of the disc (11), that has a diameter large enough to receive the disc bearing (9), but does not go all the way through the disc. The remaining material on the inner side of the disc acts as a bearing stop. This bore houses the pressed-in bearing (9).
   iv. An inner groove (14) toward the outside edge of the larger bore to hold the retaining ring (12)—hereafter referred to as the retaining ring groove.
   v. Two inner disc mounting holes (10a and 10b) positioned to line up with the previously described disc assembly mounting holes (6a and 6b) in the outer side of the wheel (1).
   vi. Optionally, a decorative design cut through or placed on the disc (8) for aesthetic purposes.
D. A standard ball bearing assembly (9) of such diameter as to fit securely in the center hole of the inner disc (11), hereafter referred to as the “disc bearing.”
E. A retaining ring (12).
F. A “disc axle screw” (13) with the following characteristics:
   i. A head that contacts and spins with the inner race of the disc bearing (9). The head of the disc axle screw (13) is received by the smaller bore on the inner side of the inner disc (11).
   ii. A threaded end that screws into the lower level shoulder of the outer disc (8). Since the previously-described disc axle screw (13) rotates with the inner race of the disc bearing (9) and the outer disc (8) is connected to the disc axle screw (13), the outer disc (8) rotates with the disc axle screw (13).
G. Two fasteners (7a and 7b) that fasten the disc assembly to the wheel (1) via the two holes (10a and 10b) in the inner disc (11) and the two disc assembly mounting holes (6a and 6b) in the wheel (1).

With Disc Assembly Configuration 1, the inner disc assembly consists of the inner disc (11), the disc bearing (9) and the retaining ring (12).

With Disc Assembly Configuration 1 the outer disc (8) is joined to the inner disc assembly with the disc axle screw (13). The resulting assembly is then joined to the wheel (1) by inserting fasteners (7a and 7b) through the access holes or decorative design of the outer disc (8), through the inner disc mounting holes (10a and 10b) of the inner disc (11) and into the disc assembly mounting holes (6a and 6b) in the wheel (1). The inner disc (11) then rotates with the wheel (1) while the outer disc (8) and disc axle screw (13) rotate independently.

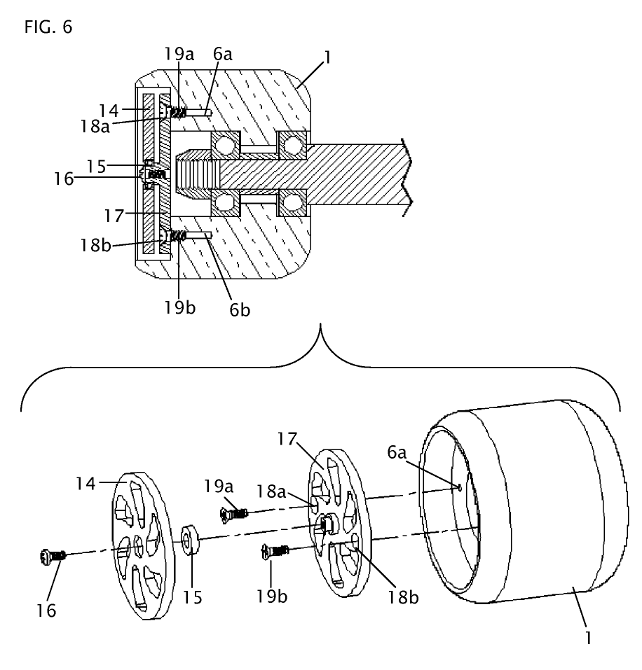

FIG. 6 shows cross-section and exploded views of the embodiment hereafter referred to as Disc Assembly Configuration 2. Disc Assembly Configuration 2 comprises the following parts:
A. The wheel (1) as previously described
B. A disc (14), hereafter referred to as the “outer disc”, with the following characteristics:
   i. A hole through the center to receive the pressed-in disc bearing (15). The outer side of this bore receives the head of the disc axle screw (16).
   ii. Access holes or a decorative design cut through the disc (14) to allow access for mounting.
C. A disc (17), hereafter referred to as the “inner disc”, with the following characteristics:
   i. A two-level shoulder positioned immediately around its hub on its outer side. The first level of the shoulder is of a larger diameter than the second level of the shoulder. The first level of the shoulder protrudes from the disc. The second level of the shoulder protrudes from the first level of the shoulder. The larger shoulder contacts the inner race of the disc bearing (15) when the outer disc (14) is joined with the inner disc (17). The smaller shoulder serves as the spindle that seats the inner race of the disc bearing (15) when the outer disc (14) and inner disc (17) are joined. The smaller shoulder contains a threaded bore to receive the disc axle screw (16). The threaded bore can be a tapped hole into the base material of the inner disc (17) or a threaded insert such as a Helicoil, Keensert, PEM nut or other threaded insert placed in the inner disc (17) to provide the necessary mating threads for the disc axle screw (16).
   ii. Two inner disc mounting holes (18a and 18b) positioned to line up with the previously described disc assembly mounting holes (6a and 6b) in the outer side of the wheel (1).
   iii. Optionally, a decorative design cut through or placed on the disc (17) for aesthetic purposes.
D. A disc bearing (15) of such diameter that it can be snugly pressed into the center hole of the outer disc (14).
E. A “disc axle screw” (16) with the following characteristics:
   i. A head that contacts and spins with the inner race of the disc bearing (15). The head of the disc axle screw (16) is received by the hole on the outer side of the outer disc (14). Optionally, the head of the disc axle screw (16) can be larger in diameter than the hole on the outer side of the outer disc (14) so that the head of the disc axle screw (16) retains the outer disc (14) should it loosen from the pressed fitting with the disc bearing (15). A cylindrical sleeve can be used in this option to retain the disc bearing (15) and provide separation between the head of the disc axle screw (16) and the outer disc (14).
   ii. A threaded end that screws into the lower level shoulder of the inner disc (17).
F. Two fasteners (19a and 19b) that fasten the disc assembly to the wheel (1) via the two holes (18a and 18b) in the inner disc (17) and the two disc assembly mounting holes (6a and 6b) in the wheel (1).

With Disc Assembly Configuration 2, the outer disc (14) is joined to the inner disc (17) by pressing the disc bearing (15) on to the smaller shoulder of the inner disc (17). The disc axle screw (16) is threaded into the smaller shoulder of the inner disc (17) to retain the disc bearing (16). The resulting assembly is then joined to the wheel (1) by inserting fasteners (19a and 19b) through the access holes or decorative design of the outer disc (14), through the inner disc mounting holes (18a and 18b) of the inner disc (17) and into the disc assembly mounting holes (6a and 6b) in the wheel (1). The inner disc (17) rotates with the wheel (1) while the outer disc (14) rotates independently.

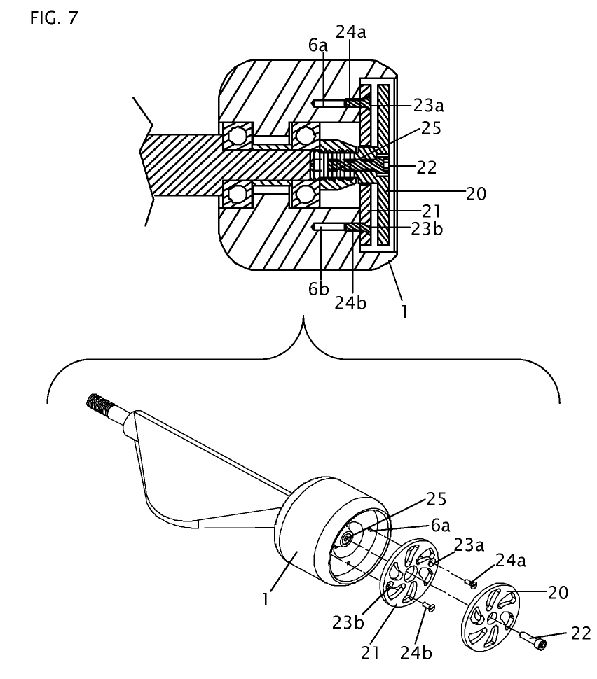

FIG. 7 shows cross-section and exploded views of the embodiment hereafter referred to as Disc Assembly Configuration 3. Disc Assembly Configuration 3 comprises the following parts:
A. The wheel (1) as previously described
B. A disc (20), hereafter referred to as the “outer disc”, with the following characteristics:
   i. A shoulder positioned immediately around its hub on its inner side. The shoulder passes through the center hole of the inner disc (21) and makes contact with the skateboard axle. The shoulder also provides a small separation between the inner disc (21) and the outer disc (20). This disc (20) remains stationary while the wheel (1) and inner disc (21) rotate behind it.
   ii. A counter bore through the shoulder area at the hub of the disc (20) that receives the mounting screw (22).
   iii. A decorative design cut through or placed on the disc (20) for aesthetic purposes.
C. A disc (21), herein referred to as the “inner disc”, with the following characteristics:
   i. A hole through the center to allow the shoulder of the outer disc (20) to pass through without making contact with the inner disc (21).
   ii. Two inner disc mounting holes (23a and 23b).
   iii. Optionally, a decorative design cut through the disc (21) for aesthetic purposes.
D. A truck assembly with threaded bores (25) located concentrically at the ends of the axles to receive the outer disc mounting screw (22).
E. A mounting screw (22) for the outer disc (20)
F. Two fasteners (24a and 24b) that fasten the inner disc (21) to the wheel (1) via the two holes (23a and 23b) in the inner disc (21) and the two disc assembly mounting holes (6a and 6b) in the wheel (1).

With Disc Assembly Configuration 3, the inner disc (21) is fastened to the wheel (1) by inserting the fasteners (24a and 24b) through the inner disc mounting holes (23a and 23b) in the inner disc (21) and into the disc assembly mounting holes in the wheel (6a and 6b). The outer disc (20) attaches to the threaded bore in the axle (25) with the outer disc mounting screw (22). The inner disc (21) then rotates with the wheel (1) while the outer disc (20) remains stationary.

What is claimed is:

1. A cylindrical wheel comprising, in no particular order, a series of specially positioned and sized bores, centered around the axis of the wheel, to accommodate and house an axle, axle nut, a standard ball bearing assembly hereafter called the “inner axle bearing”, another standard ball bearing assembly hereafter called the “outer axle bearing”, and a disc assembly—one bore (the “axle bore”) extending fully through the axis of said wheel and of a diameter to receive said axle, another bore (the “inner axle bearing bore”) of a diameter that snugly holds said inner axle bearing and extends into the inner side of said wheel to a depth not exceeding the width of said inner axle bearing, another bore (the “outer axle bearing bore”) on the outer side of said wheel which is of a diameter to snugly house said outer axle bearing and extends to a depth of the sum width of said outer axle bearing plus the width needed to accommodate said axle nut plus any space occupied past said axle nut by said axle threads plus the width of a bore to house said disc assembly (the “disc assembly bore”)—leaving wheel material between said outer axle bearing bore and said inner axle bearing bore, said disc assembly bore which is larger in diameter than said outer axle bearing bore and extends into the outer side of said wheel to a depth that will house said disc assembly without impeding on the outer axle bearing area, and a plurality of holes positioned concentrically within the diameter of said disc assembly bore but outside the diameter of said outer axle bearing bore to serve as tap holes for mounting said disc assembly.

2. An embodiment that includes a plurality of rotating discs and components (hereafter referred to as a “disc assembly”) used in conjunction with the wheel as described in claim 1, comprising, in no particular order:
an outer disc that rotates independently of an inner disc comprising two or more mounting access holes or decorative cutouts that align with mounting holes of said inner disc, optional decorative cutouts through, or logos on or into, its surface, and a two-level shoulder positioned around its hub on its inner side—the larger diameter inner shoulder to contact the inner race of a standard ball bearing assembly (the “disc bearing”) and the smaller diameter outer shoulder to serve as a spindle that seats the inner race of said disc bearing and contains a threaded bore to receive a machine screw that joins said inner disc to said outer disc;
said inner disc that is fastened to and rotates with said wheel comprising two or more said mounting holes that line up with tap holes in said wheel, optional decorative cutouts through, or logos on, its surface, a shoulder surrounding its hub to the outer side to hold said disc bearing and a retaining ring, a bore through the center axis of said shoulder that is slightly larger in diameter than the outmost edge of the inner race of said disc bearing but not larger in diameter than said disc bearing itself, a bore in the center of said shoulder on the outer side of the said inner disc that has a diameter large enough to receive said pressed-disc bearing but does not go all the way through said inner disc (the remaining material on the inner side of said inner disc acting as a bearing stop), and an inner groove toward the outer side of said larger bore to hold said retaining ring;
said “disc bearing”, which is a standard ball bearing assembly of such diameter as to fit securely in said center hole of said inner disc;
said retaining ring that snaps into said groove inside said center bore of said inner disc and retains said disc bearing in said inner disc;
said machine screw that fastens said inner disc to said outer disc, rotates with said inner race of said disc bearing and said outer disc, and has a threaded end that screws into said lower level shoulder of said outer disc; and
a plurality of fasteners that mount said disc assembly to said wheel using said mounting holes of said inner disc and said tap holes in said wheel.

3. An embodiment that includes a plurality of rotating discs and components (hereafter referred to as a “disc assembly”) used in conjunction with the wheel as described in claim 1, comprising, in no particular order:
an outer disc that rotates independently of an inner disc comprising two or more mounting access holes and/or decorative cutouts that align with the mounting holes of said inner disc, optional decorative cutouts through, or logos on, its surface, and a bore through its hub to receive a pressed-in ball bearing assembly (the “disc bearing”);
said inner disc that is fastened to and rotates with said wheel comprising two or more mounting holes that align with tap holes in said wheel, optional decorative cutouts through, or logos on, its surface, and a two-level shoulder positioned around its hub on its outer side—the larger diameter inner shoulder to contact the inner race of said disc bearing and the smaller diameter outer shoulder to serve as a spindle that seats the inner race of said disc bearing and contains a threaded bore to receive a machine screw that joins said outer disc to said inner disc;
said standard ball bearing assembly that allows said outer disc to rotate independently of said inner disc, of such diameter as to fit securely in said center hole of said outer disc;
said machine screw—the head of which has a diameter that exceeds that of said inner race of said disc bearing—that fastens said outer disc and said disc bearing to said inner disc via said threaded bore in the center of said smaller shoulder of said inner disc;
an optional cylindrical sleeve that is placed between said head of said machine screw and the inner race of said disc bearing that acts as a spacer between said head of said machine screw and the outside face of said outer disc; and
a plurality of fasteners that mount said disc assembly to said wheel via said mounting holes in said inner disc and said tap holes in said wheel.

4. An embodiment that includes a plurality of rotating and non-rotating discs and components used in conjunction with the wheel as described in claim 1, comprising, in no particular order:
a machine screw that fastens an outer disc to a threaded bore in the axle hub of a truck assembly;
said outer disc (that remains stationary while an inner disc and wheel rotate behind it) comprising two or more mounting access holes and/or decorative cutouts (that align with the mounting holes of said inner disc), optional decorative cutouts through, or logos on, its surface, a shoulder area positioned around its hub on its inner side, and a bore through said shoulder area at the disc hub that receives said machine screw;
said inner disc that is mounted to and spins with said wheel comprising two or more said mounting holes that align with tap holes in said wheel, optional decorative cutouts through, or logos on, its surface, and a bore through its hub that allows said shoulder of the said outer disc to pass through without making contact with said inner disc;
said truck assembly wherein each threaded end of the axle contains a threaded bore that receives said machine screw that fastens said outer disc to said axle; and
a plurality of fasteners that mount said inner disc to said wheel via said mounting holes of said inner disc and said tap holes in said wheel.
